(19) United States
(12) Patent Application Publication
(10) Pub. No.: US 2025/0000095 A1
(43) Pub. Date: Jan. 2, 2025

(54) A STABLE HERBICIDAL COMPOSITION

(71) Applicants: UPL CORPORATION LIMITED, Port Louis (MU); UPL EUROPE LTD, Cheshire (GB)

(72) Inventors: Adrien MERTES, Ougrée (BE); Alan PIROTTE, Ougrée (BE)

(21) Appl. No.: 18/706,290

(22) PCT Filed: Nov. 2, 2022
(86) PCT No.: PCT/GB2022/052757

§ 371 Date: Apr. 30, 2024

(30) Foreign Application Priority Data
Nov. 3, 2021 (IN) 202121050620

(51) Int. Cl. A01N 47/36; A01N 25/08; A01N 25/10; A01N 25/14; A01N 25/22; A01P 13/00

(52) U.S. Cl. CPC A01N 47/36; A01N 25/08; A01N 25/10; A01N 25/14; A01N 25/22; A01P 13/00

(57) ABSTRACT

The present disclosure relates to a stable agrochemical composition comprising one or more triazinylsulfonylurea herbicide(s). The present disclosure also relates to a process for preparing the stable herbicidal composition and a method for using the same.

### FIELD OF INVENTION

The present disclosure relates to a stable agrochemical composition. More particularly, the present disclosure relates to a solid herbicidal composition comprising one or more triazinylsulfonylurea herbicide(s). The present disclosure also relates to a process for preparing the stable herbicidal composition and a method for using the same.

### BACKGROUND OF THE INVENTION

Among the agricultural crop pests, weeds are the most potent crop pests reducing yields in the agricultural crops. Weeds are unwanted/undesired plants that interfere with the agricultural practices, compete with the crops for available nutrient resources and space, as well as reduce growth, yield, and quality of agricultural crops. Generally, weeds produce a larger number of seeds, which remain dormant in the soil for several years. Furthermore, weeds exhibit the ability to invade newly disturbed areas and compete with the main crops for scarcely available moisture, nutrients, and light. Apart from yield and production losses, weeds may also provide niches and harbour insects, plant pathogens, and other pests, hence increasing the incidence of attack of pests to the main crop. Therefore, the control of the unwanted/undesired plant or weed growth is crucial to obtain high yield in agricultural crops and is one of the main objectives in the agricultural field.

Herbicides are chemical compounds used to control unwanted plants/weeds. Among the herbicides, substituted urea herbicides (SUHs) are a large group of non-selective herbicidal agents. The SUHs are often applied for nuisance broadleaf weed and grass control in such non-crop areas as roadsides and drainage ditches, but many also have registered pre- and post-emergence applications for certain crops. Most SUHs bind to soils and are taken up by plant roots. Substitution of phenyl or sulfonyl chemical groups onto the urea structure are the two main types of SUHs. They comprise pyrimidinylsulfonylureas and triazinylsulfonylureas. The sulfonylureas inhibit the plant enzyme called acetolactate synthase, thereby resulting in an impaired branched-chain amino acid synthesis.

Triazinylsulfonylurea herbicides are highly active herbicides. Two of the known triazinylsulfonyurea herbicides are tribenuron-methyl and thifensulfuron-methyl herbicides.

Tribenuron-methyl (TBM), methyl 2-[[(4-methoxy-6-methyl-1,3,5-triazin-2-yl)-methylcarbamoyl] sulfamoyl] benzoate, is a member of the sulfonylurea herbicide family. It controls weeds by inhibiting the synthesis of branched-chain amino acids (valine and isoleucine), and thereby stopping cell division and weed growth. Tribenuron-methyl is generally used in agricultural weed control for cereal crops, especially rice.

Thifensulfuron-methyl, methyl 3-[(4-methoxy-6-methyl-1,3,5-triazin-2-yl) carbamoylsulfamoyl] thiophene-2-carboxylate is a sulfonylurea herbicide for post-emergence broadleaf weed control in wheat, barley, and soybeans.

Similar to other agrochemicals, triazinylsulfonylurea herbicides can be formulated as concentrates in a variety of different forms, such as wettable powders (WP), water dispersible granules (WDG) and tablets (TB). One of the shortcomings of the WP formulations of triazinylsulfonylurea herbicides is that it poses dust challenge while manufacturing, which adversely impacts formulators health. Moreover, WP also brings pollution problems of residual triazinylsulfonylurea herbicides contamination of the spray equipment. On the other hand, TB formulation of the herbicidal composition is easy to measure and use. However, TB formulation is attractive to children and pets, and poses ingestion risk. Compared to WP and TB, the WDG formulation is easily measured and mixed. Because of low dust of WDG, they cause less inhalation hazard to the applicator during handling.

Furthermore, the triazinylsulfonylurea herbicides are prone to hydrolysis and hence great care is required while developing its formulation as well as during application of these herbicides. The natural degradation of sulfonylurea herbicides takes place through aqueous hydrolysis reactions, microbial processes (mainly occurring in soils), or photodegradation reactions. Among triazinylsulfonylurea herbicides, tribenuron-methyl is prone to hydrolysis in the presence of water. The cleavage of the sulfonylurea bridge is the major initial chemical reaction for the degradation, especially under acidic conditions. Therefore, it may degrade when it is tank mixed with other active ingredients with varying pH values.

Therefore, there exists a need to develop a robust formulation of triazinylsulfonylurea herbicides, especially in the form of WDG, which remains stable during shelf life and also resists uncontrollable degradation of triazinylsulfonylurea when it is diluted with water during tank-mix before application onto undesirable/unwanted plants or weeds.

### OBJECTIVES OF THE DISCLOSURE

It is a primary objective of the present disclosure to provide a stable agrochemical composition comprising triazinylsulfonylurea herbicide(s).

Another objective of the present disclosure is to provide a process for preparation of a stable agrochemical composition comprising triazinylsulfonylurea herbicide(s).

Another objective of the present disclosure is to provide a method for controlling undesired plants/wands using the stable agrochemical composition comprising triazinylsulfonylurea herbicide(s).

### SUMMARY OF THE INVENTION

In one aspect of the present disclosure, the disclosure provides an agrochemical composition comprising:
a) at least one triazinylsulfonylurea herbicide, its agriculturally acceptable salts, and esters thereof; and
b) a stabilizer system comprising a polymeric carrier and at least two salts of sulfonic acid derivatives;
   wherein the stabilizer system controls degradation of the triazinylsulfonylurea herbicide in a spray solution.

In another aspect, the present disclosure provides an agrochemical composition comprising:
a) at least two triazinylsulfonylurea herbicides, its agriculturally acceptable salts, and esters thereof; and
b) a stabilizer system comprising a silicate carrier and at least two salts of sulfonic acid derivatives;
   wherein the stabilizer system controls degradation of the triazinylsulfonylurea herbicides in a spray solution.

In another aspect, the present disclosure provides an agrochemical composition comprising:
a) at least two triazinylsulfonylurea herbicides, its agriculturally acceptable salts, and esters thereof; and
b) a stabilizer system comprising a silicate carrier; and at least two salts of sulfonic acid derivatives in a ratio ranging from 1:1 to 20:1;
   wherein the stabilizer system controls degradation of the triazinylsulfonylurea herbicides up to 80% in a spray solution.

In another aspect, the present disclosure, provides a process for preparation of a stable agrochemical composition comprising at least one triazinylsulfonylurea herbicide, its agriculturally acceptable salts and esters thereof; and a stabilizer system comprising a silicate carrier and at least two salts of sulfonic acid derivatives; wherein stabilizer system controls degradation of triazinylsulfonylurea herbicide; and wherein said process comprising steps of:
a) mixing at least one triazinylsulfonylurea herbicide and a stabilizer system comprising a polymeric carrier and at least two salts of sulfonic acid derivatives to obtain a homogeneous mixture;
b) granulating the homogeneous mixture of step (a) to obtain granules; and
c) drying the granules to obtain the stable agrochemical composition.

In another aspect, the present disclosure provides a method for controlling unwanted plants/weeds by applying to the plants or to their locus thereof, a stable agrochemical composition comprising at least one triazinylsulfonylurea herbicide, its agriculturally acceptable salts, and esters thereof; and a stabilizer system comprising a polymeric carrier and at least two salts of sulfonic acid derivatives.

In another aspect of the present disclosure, the stable agrochemical composition is used for controlling growth of undesired/unwanted plants/weeds.

### DETAILED DESCRIPTION OF THE DISCLOSURE

Those skilled in art will be aware that the disclosure described herein is subject to variations and modifications other than those specifically described. It is to be understood that the disclosure described herein includes all such variations and modifications. The disclosure also includes all such steps, features, compositions, and methods referred to or indicated in this specification, individually or collectively, and any and all combinations of any two or more said steps or features.

For the purposes of the following detailed description, it is to be understood that the disclosure may assume various alternative variations and step sequences, except where explicitly specified to be contrary. Moreover, other than in the operating examples, or where otherwise indicated, all numbers expressing quantities of ingredients, reaction conditions and so forth used in the specification and claims are to be understood as being modified in all instances by the term “about.”

Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa; e.g., the singular forms “a,” “an,” and “the” include plural referents unless expressly and unequivocally limited to one referent.

As used herein, the terms “comprising” “including,” “having,” “containing,” “involving,” and the like are to be understood to be open-ended, i.e., to mean including but not limited to.

The term “about” or “approximately” as used herein is inclusive of the stated value and means within an acceptable range of deviation for particular value as determined by one of ordinary skill in the art, considering the measurement in question and the error associated with measurement of the particular quantity (i.e., the limitations of the measurement system). For example, “about” can mean within one or more standard deviations, or within ±10 or ±5 of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

The aspects and embodiments described herein shall also be interpreted to replace the clause “comprising” with either “consisting of” or with “consisting essentially of” or with “consisting substantially of”.

The terms “plants” and “vegetation” include, but are not limited to, germinant seeds, emerging seedlings, plants emerging from vegetative propagules, and established vegetation. The term “locus” as used herein shall denote the vicinity of a desired crop in which weed control, typically selective weed control, of weeds is desired. The locus includes the vicinity of desired crop plants wherein the weed infestation has either emerged or is yet to emerge. The term crop shall include a multitude of desired crop plants or an individual crop plant growing at a locus.

With respect to the present disclosure, the term “stable” as used herein is intended to refer to physically stable compositions; i.e., water dispersible compositions that remains stable without any substantial degradation of actives and inert present in it during shelf life as well as upon diluting it with water to make a spray solution.

With respect to the present disclosure, the term ‘spray solution’ means agriculturally acceptable dilution of the stable herbicidal composition with water for the purpose of treating undesired vegetation.

As used herein, the term ‘pre-emergence’ refers to the time point before seedlings emerge from the ground. When any herbicide is applied at pre-emergence stage, it prevents establishment of the germinated weed seedlings.

As used herein, the term ‘post-emergence’ refers to the time point after seedlings emerge from the ground. When any herbicide is applied at post-emergence stage, it prevents growth of the germinated weed seedlings.

It has now surprisingly been found that the degradation of triazinylsulfonylurea herbicide, preferably tribenuron-methyl can be prevented by incorporating a stabilizer comprising a polymeric carrier and at least two salts of sulfonic acid derivatives in the WDG composition. Once the WDG is dispersed in water to obtain spray solution for end-use, the stabilizer comprising the polymeric carrier and salts of sulfonic acid derivatives in the WDG composition prevents its degradation and therefore enhances the life of spray solution of triazinylsulfonylurea herbicides which is often made in tanks to be sprayed onto crops. Thus, the spray solution can be kept for a longer period of time without substantial degradation of triazinylsulfonylurea herbicides.

Therefore, according to an embodiment, there is provided a stable agrochemical composition comprising:
a) at least one triazinylsulfonylurea herbicide, its agriculturally acceptable salts, and esters thereof; and
b) a stabilizer system comprising a polymeric carrier and at least two salts of sulfonic acid derivatives;
   wherein the stabilizer system controls degradation of the triazinylsulfonylurea herbicide.

According to an embodiment, the triazinylsulfonylurea herbicide is selected from the group consisting of chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, its agriculturally acceptable salts, and esters thereof.

According to an embodiment, the triazinylsulfonylurea herbicide is tribenuron.

According to an embodiment, the triazinylsulfonylurea herbicide is tribenuron-methyl.

According to an embodiment, the triazinylsulfonylurea herbicide is thifensulfuron.

According to an embodiment, the triazinylsulfonylurea herbicide is thifensulfuron-methyl.

According to an embodiment, the stable agrochemical composition comprises triazinylsulfonylurea herbicide in an amount from about 0.1% w/w to about 80% w/w of the total weight of the stable agrochemical composition.

According to an embodiment, the stable agrochemical composition comprises triazinylsulfonylurea herbicide in an amount from about 0.5% w/w to about 70% w/w of the total weight of the stable agrochemical composition.

In a preferred embodiment, the stable agrochemical composition comprises triazinylsulfonylurea herbicide in an amount from about 1% w/w to about 60% w/w of the total weight of the stable agrochemical composition.

In a preferred embodiment, the stable agrochemical composition comprises tribenuron-methyl in an amount from about 1% w/w to about 60% w/w of the total weight of the stable agrochemical composition.

In a preferred embodiment, the stable agrochemical composition comprises thifensulfuron-methyl in an amount from about 1% w/w to about 60% w/w of the total weight of the stable agrochemical composition.

According to an embodiment, the stabilizer system comprises a polymeric carrier and at least two salts of sulfonic acid derivatives.

According to an embodiment, the polymeric carrier is a silicate carrier.

According to an embodiment, the silicate carrier is selected from the group consisting of kaolin clay and bentonite clays, which may be natural bentonites or modified e.g., activated bentonites, synthetic and diatomaceous silicas, and mixtures thereof.

According to an embodiment, the silicate carrier is kaolin (China clay).

According to an embodiment, the stable agrochemical composition comprises the polymeric carrier in an amount from about 1% w/w to about 80% w/w of the total weight of the stable agrochemical composition.

According to an embodiment, the stable agrochemical composition comprises the polymeric carrier in an amount from about 5% w/w to about 70% w/w of the total weight of composition.

In a preferred embodiment, the stable agrochemical composition comprises the polymeric carrier from about 10% w/w to about 60% w/w of the total weight of the composition.

In a preferred embodiment, the stable agrochemical composition comprises the silicate carrier from about 10% w/w to about 60% w/w of the total weight of the composition.

According to an embodiment, the stabilizer system comprises at least two salts of sulfonic acid derivatives.

According to an embodiment, the salts of sulfonic acid derivative are selected from the group consisting of alkyl naphthalene sulfonates, preferably having alkyl groups with 1-10 carbon atoms, such as methyl, isopropyl, n-butyl, sec-butyl, and nonyl, e.g., sodium butyl naphthalene sulfonate and sodium nonyl naphthalene sulfonate. Examples of commercial alkyl naphthalene sulfonates are Morwet® B, Morwet IP, sodium alkyl naphthalene sulfonate blend (Morwet EFW) and alkylnaphthalene sulfonate salt (Rhodacal BX 78). An example of a suitable commercial condensate is Morwet D-425. Similarly, lignosulphonates, salts of lignosulfonates, modified sodium lignosulfonate (Borresperse 3A), condensate of aromatic sulfonic acids such as Baykanol SL, TANIGAN® WLF, Sodium Isopropyl Naphthalene Sulfonate (supragil WP), sodium lignosulfonate, Sodium dodecylbenzenesulfonate & Sodium polycarboxylate mixture (Geropon TA 72), sodium lauryl sulfate (Agnique 2490 PB), calcium dinonyl naphthalene sulfonate, linear dodecylbenzene sulfonic acid, branched dodecylbenzene sulfonic acid, linear dodecylbenzene sulfonate isopropylamine salt, naphthalene sulfonate-formaldehyde condensates, alkyl substituted naphthalene sulfonate-formaldehyde condensates, sodium alkyl naphthalene sulfonate, sodium salt of sulfonated naphthalene-formaldehyde condensate.

According to a preferred embodiment, at least two salts of sulfonic acid derivative are selected from the group comprising of sodium alkylsulphonate, sodium lignosulfonate, sodium dodecylbenzenesulphonate, and mixtures thereof.

According to a preferred embodiment, at least two salts of sulfonic acid derivatives are sodium alkylsulphonate and sodium lignosulfonate.

According to a preferred embodiment, at least two salts of sulfonic acid derivatives are sodium dodecylbenzenesulfonate and sodium lignosulphonate.

According to a preferred embodiment, at least two salts of sulfonic acid derivatives are sodium alkylsulphonate and dodecylbenzenesulfonate.

According to an embodiment, the stable agrochemical composition comprises two salts of sulfonic acid derivative in an amount from about 0.1% w/w to about 25% w/w of the total weight of the stable agrochemical composition.

According to an embodiment, the stable agrochemical composition comprises two salts of sulfonic acid derivative in an amount from about 1% w/w to about 20% w/w of the total weight of the composition.

In a preferred embodiment, the stable agrochemical composition comprises from about 5% w/w to about 15% w/w two salts of sulfonic acid derivative of the total weight of the composition.

According to an embodiment, a stable agrochemical composition comprises:
a) at least two triazinylsulfonylurea herbicides, its agriculturally acceptable salts, and esters thereof; and
b) a stabilizer system comprising a silicate carrier and at least two salts of sulfonic acid derivatives;
   wherein the stabilizer system controls degradation of the triazinylsulfonylurea herbicides.

According to an embodiment, the stable agrochemical composition comprises at least two triazinylsulfonylurea herbicides, its agriculturally acceptable salts, and esters thereof.

According to an embodiment, the stable agrochemical composition comprises tribenuron-methyl and thifensulfuron-methyl.

According to an embodiment, the stable agrochemical composition comprises tribenuron-methyl and metsulfuron or its derivative.

According to an embodiment, the stable agrochemical composition comprises tribenuron-methyl and chlorsulfuron or its derivative.

According to an embodiment, the stable agrochemical composition comprises thifensulfuron-methyl and chlorsulfuron or its derivative.

According to an embodiment, the stable agrochemical composition comprises thifensulfuron-methyl and metsulfuron or its derivative.

According to an embodiment, the stable agrochemical composition comprises thifensulfuron-methyl and tribenuron-methyl in a ratio ranging from 1:1 to 1:70.

According to an embodiment, the stable agrochemical composition comprises thifensulfuron-methyl and tribenuron-methyl in a ratio ranging from 1:1 to 1:50.

According to an embodiment, the stable agrochemical composition comprises thifensulfuron-methyl and tribenuron-methyl in a ratio ranging from 1:1 to 1:30.

According to an embodiment, the stable agrochemical composition comprises thifensulfuron-methyl and tribenuron-methyl in a ratio ranging from 1:1 to 1:15.

According to an embodiment, the stable agrochemical composition comprises thifensulfuron-methyl and tribenuron-methyl in a ratio of 1:9.

According to an embodiment, a stable agrochemical composition comprises:
a) at least two triazinylsulfonylurea herbicides, its agriculturally acceptable salts, and esters thereof; and
b) a stabilizer system comprising a polymeric carrier; and at least two salts of sulfonic acid derivatives in a ratio ranging from 1:1 to 20:1;
   wherein the stabilizer system controls degradation of the triazinylsulfonylurea herbicides up to 80%.

According to an embodiment, a stable agrochemical composition comprises:
a) at least two triazinylsulfonylurea herbicides, its agriculturally acceptable salts, and esters thereof; and
b) a stabilizer system comprising a silicate carrier; and at least two salts of sulfonic acid derivatives in a ratio ranging from 1:1 to 20:1;
   wherein the stabilizer system controls degradation of the triazinylsulfonylurea herbicides up to 80%.

According to an embodiment, the stabilizer system of the stable agrochemical composition comprises a silicate carrier; and at least two salts of sulfonic acid derivatives in a ratio ranging from 1:1 to 20:1.

According to a preferred embodiment, the stabilizer system of the stable agrochemical composition comprises a silicate carrier; and at least two salts of sulfonic acid derivatives in a ratio ranging from 1:1.

According to an embodiment, the stabilizer system of the stable agrochemical composition comprises a silicate carrier; and at least two salts of sulfonic acid derivatives in a ratio ranging from 2:1.

According to an embodiment, the stabilizer system of the stable agrochemical composition comprises a silicate carrier; and at least two salts of sulfonic acid derivatives in a ratio ranging from 3:1.

According to an embodiment, the stabilizer system of the stable agrochemical composition comprises a silicate carrier; and at least two salts of sulfonic acid derivatives in a ratio ranging from 4:1.

According to an embodiment, the stabilizer system of the stable agrochemical composition comprises a silicate carrier; and at least two salts of sulfonic acid derivatives in a ratio ranging from 5:1.

According to an embodiment, the stabilizer system of the stable agrochemical composition comprises a silicate carrier; and at least two salts of sulfonic acid derivatives in a ratio ranging from 10:1.

According to an embodiment, the stabilizer system of the stable agrochemical composition comprises at least two salts of sulfonic acid derivatives, wherein the two salts of sulfonic acid derivatives are sodium lignosulfonate and sodium alkylsulphonate.

According to an embodiment, the stabilizer system of the stable agrochemical composition comprises at least two salts of sulfonic acid derivatives, wherein sodium lignosulfonate and sodium alkylsulphonate are present in a ratio of 3:1.

According to an embodiment, the stabilizer system of the stable agrochemical composition comprises at least two salts of sulfonic acid derivatives, wherein the two salts of sulfonic acid derivatives are sodium dodecylbenzenesulphonate and sodium alkylsulphonate.

According to an embodiment, the stabilizer system of the stable agrochemical composition comprises at least two salts of sulfonic acid derivatives, wherein sodium dodecylbenzenesulphonate and sodium alkylsulphonate are present in a ratio of 3:1.

According to an embodiment, the stabilizer system controls degradation of the triazinylsulfonylurea herbicide. Furthermore, the stabilizer system controls degradation of the triazinylsulfonylurea herbicide in a spray solution.

According to an embodiment, the stabilizer system controls degradation of triazinylsulfonylurea herbicide, when the stable agrochemical composition is diluted with water upon its application.

According to an embodiment, the stabilizer system controls degradation of tribenuron-methyl, when the stable agrochemical composition is diluted with water upon its application.

According to an embodiment, the stabilizer system controls degradation of thifensulfuron-methyl, when the stable agrochemical composition is diluted with water upon its application.

According to an embodiment, the stabilizer system controls 95% degradation of triazinylsulfonylurea herbicide, when the stable agrochemical composition is diluted with water upon its application.

According to an embodiment, the stabilizer system controls 95% degradation of tribenuron-methyl, when the stable agrochemical composition is diluted with water upon its application.

According to an embodiment, the stabilizer system controls 95% degradation of thifensulfuron-methyl, when the stable agrochemical composition is diluted with water upon its application.

According to an embodiment, the stabilizer system controls 90% degradation of triazinylsulfonylurea herbicide, when the stable agrochemical composition is diluted with water upon its application.

According to an embodiment, the stabilizer system controls 90% degradation of tribenuron-methyl, when the stable agrochemical composition is diluted with water upon its application.

According to an embodiment, the stabilizer system controls 90% degradation of thifensulfuron-methyl, when the stable agrochemical composition is diluted with water upon its application.

According to an embodiment, the stabilizer system controls 85% degradation of triazinylsulfonylurea herbicide, when the stable agrochemical composition is diluted with water upon its application.

According to an embodiment, the stabilizer system controls 85% degradation of tribenuron-methyl when the stable herbicidal composition is diluted with water upon its application.

According to an embodiment, the stabilizer system controls 85% degradation of thifensulfuron-methyl, when the stable agrochemical composition is diluted with water upon its application.

According to an embodiment, the stabilizer system controls 95% or more degradation of triazinylsulfonylurea herbicide in spray solution.

According to an embodiment, the stabilizer system controls 95% or more degradation of tribenuron-methyl in spray solution.

According to an embodiment, the stabilizer system controls 95% or more degradation of thifensulfuron-methyl in spray solution.

According to an embodiment, the stabilizer system controls 90% or more degradation of triazinylsulfonylurea herbicide in spray solution.

According to an embodiment, the stabilizer system controls 90% or more degradation of tribenuron-methyl in spray solution.

According to an embodiment, the stabilizer system controls 90% or more degradation of thifensulfuron-methyl in spray solution.

According to an embodiment, the stabilizer system controls more than 85% or more degradation of triazinylsulfonylurea herbicide in spray solution.

According to an embodiment, the stabilizer system controls 85% or more degradation of tribenuron-methyl in spray solution.

According to an embodiment, the stabilizer system controls 85% or more degradation of thifensulfuron-methyl in spray solution.

According to an embodiment, the stabilizer system controls more than 80% or more degradation of triazinylsulfonylurea herbicide in spray solution.

According to an embodiment, the stabilizer system controls 80% or more degradation of tribenuron-methyl in spray solution.

According to an embodiment, the stabilizer system controls 80% or more degradation of thifensulfuron-methyl in spray solution.

According to an embodiment, the stabilizer system controls 95% or more degradation of triazinylsulfonylurea herbicide(s) up to 30 minutes when the stable agrochemical composition is diluted with water to prepare spray solution for its application.

According to an embodiment, the stabilizer system controls 95% or more degradation of tribenuron-methyl up to 30 minutes when the stable agrochemical composition is diluted with water to prepare spray solution for its application.

According to an embodiment, the stabilizer system controls 95% or more degradation of thifensulfuron-methyl up to 30 minutes when the stable agrochemical composition is diluted with water to prepare spray solution for its application.

According to an embodiment, the stabilizer system controls 90% or more degradation of triazinylsulfonylurea herbicide(s) up to 1 hour when the stable agrochemical composition is diluted with water to prepare spray solution for its application.

According to an embodiment, the stabilizer system controls 90% or more degradation of tribenuron-methyl up to 1 hour when the stable agrochemical composition is diluted with water to prepare spray solution for its application.

According to an embodiment, the stabilizer system controls 90% or more degradation of thifensulfuron-methyl up to 1 hour when the stable agrochemical composition is diluted with water to prepare spray solution for its application.

According to an embodiment, the stabilizer system controls more than 85% degradation of triazinylsulfonylurea herbicide(s) up to 5 hours when the stable agrochemical composition is diluted with water to prepare spray solution for its application.

According to an embodiment, the stabilizer system controls 85% or more degradation of tribenuron-methyl up to 5 hours when the stable agrochemical composition is diluted with water to prepare spray solution for its application.

According to an embodiment, the stabilizer system controls 85% or more degradation of thifensulfuron-methyl up to 5 hours when the stable agrochemical composition is diluted with water to prepare spray solution for its application.

According to an embodiment, the stabilizer system controls more than 80% degradation of triazinylsulfonylurea herbicide(s) up to 24 hours minutes when the stable agrochemical composition is diluted with water to prepare spray solution for its application.

According to an embodiment, the stabilizer system controls 80% or more degradation of tribenuron-methyl up to 24 hours when the stable agrochemical composition is diluted with water to prepare spray solution for its application.

According to an embodiment, the stabilizer system controls 80% or more degradation of thifensulfuron-methyl up to 24 hours when the stable agrochemical composition is diluted with water to prepare spray solution for its application.

According to an embodiment, a spray solution of the stable agrochemical composition comprises:
a) at least one triazinylsulfonylurea herbicide, its agriculturally acceptable salts, and esters thereof,
b) a diluent; and
c) a stabilizer system comprising a silicate carrier; and at least two salts of sulfonic acid derivatives in a ratio ranging from 1:1 to 20:1;
   wherein the stabilizer system controls degradation of the triazinylsulfonylurea herbicide up to 80%.

According to an embodiment, the diluent is water.

According to an embodiment, a spray solution of the stable agrochemical composition comprising at least one triazinylsulfonylurea herbicide, its agriculturally acceptable salts and esters thereof is obtained when the composition is mixed with a diluent for application purpose.

According to an embodiment, a spray solution of the stable agrochemical composition comprising at least one triazinylsulfonylurea herbicide, its agriculturally acceptable salts and esters thereof is obtained when the composition is mixed with water for application purpose.

According to an embodiment, a spray solution of the stable agrochemical composition comprising at least two triazinylsulfonylurea herbicides, its agriculturally acceptable salts and esters thereof is obtained when the composition is mixed with a diluent for application purpose.

According to an embodiment, a spray solution of the stable agrochemical composition comprising at least two triazinylsulfonylurea herbicides, its agriculturally acceptable salts and esters thereof is obtained when the composition is mixed with water for application purpose.

According to an embodiment, triazinylsulfonylurea herbicides in the spray solution does not degrade for up to 24 hours.

According to an embodiment, triazinylsulfonylurea herbicides in the spray solution does not degrade for up to 48 hours.

According to an embodiment, the stable agrochemical composition comprises:
a) at least one triazinylsulfonylurea herbicide, its agriculturally acceptable salts, and esters thereof;
b) a stabilizer system comprising a silicate carrier; and at least two salts of sulfonic acid derivatives in a ratio ranging from 1:1 to 20:1; and
c) at least one agrochemically acceptable excipient.

According to an embodiment of the present disclosure, the agrochemically acceptable excipients are selected from one or more of colorants, binders, antifoaming agents, antioxidants, solvents, preservatives, bases, or combinations thereof.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

In an embodiment, binder may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum Arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

According to an embodiment, antifoaming agent may be selected from polydimethoxysiloxane, polydimethylsiloxane, alkyl poly acrylates, castor oil, fatty acids, fatty acids esters, fatty acids sulfate, fatty alcohol, fatty alcohol esters, fatty alcohol sulfate, foot olive oil, mono & di glyceride, paraffin oil, paraffin wax, poly propylene glycol, silicones oil, vegetable fats, vegetable fats sulfate, vegetable oil, vegetable oil sulfate, vegetable wax, vegetable wax sulfate, agents based on silicon or magnesium stearate.

The agrochemical composition may also comprise one or more antioxidants. Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA, EGTA, phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to the disclosure, suitable derivatives (salts, esters, sugars, nucleotides, nucleosides, peptides, and lipids) and mixtures of these specified active ingredients or plant extracts (e.g., tea tree oil, rosemary extract and rosemarinic acid) which comprise these antioxidants can be used. In general, mixtures of the aforementioned antioxidants are possible.

According to an embodiment, examples of suitable solvents are water, aromatic solvents (for example, xylene), water, paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

In another embodiment, suitable preservatives are for example benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl and benzoic acid.

In another embodiment, suitable base is sodium carbonate.

According to an embodiment, the stable agrochemical composition comprises agrochemically acceptable excipients in an amount from about 0.1% w/w to about 30% w/w of the total weight of the composition.

According to an embodiment, the stable agrochemical composition comprises triazinylsulfonylurea herbicide in an amount from about 0.1% w/w to about 80% w/w, a polymeric carrier in an amount from about 5% w/w to about 70% w/w and salt(s) of sulfonic acid derivative in an amount from about 1% w/w to about 20% w/w of the total weight of the composition.

According to an embodiment, the stable agrochemical composition comprises triazinylsulfonylurea herbicide in an amount from about 0.1% w/w to about 80% w/w, the silicate carrier in an amount from about 5% w/w to about 70% w/w and salt(s) of sulfonic acid derivative in an amount from about 1% w/w to about 20% w/w of the total weight of the composition.

According to an embodiment, the stable agrochemical composition comprises triazinylsulfonylurea herbicide in an amount from about 0.1% w/w to about 60% w/w, the polymeric carrier in an amount from about 5% w/w to about 70% w/w, the salt(s) of sulfonic acid derivative in an amount from about 1% w/w to about 20% w/w and the agrochemically acceptable excipient in an amount from about 0.1% w/w to about 30% w/w of the total weight of the composition.

According to an embodiment, the stable agrochemical composition comprises triazinylsulfonylurea herbicide in an amount from about 0.1% w/w to about 70% w/w, a polymeric carrier in an amount from about 5% w/w to about 60% w/w and salt(s) of sulfonic acid derivative in an amount from about 1% w/w to about 20% w/w of the total weight of the composition.

According to an embodiment, the stable agrochemical composition comprises triazinylsulfonylurea herbicide in an amount from about 0.1% w/w to about 70% w/w, the silicate carrier in an amount from about 5% w/w to about 60% w/w and salt(s) of sulfonic acid derivative in an amount from about 1% w/w to about 20% w/w of the total weight of the composition.

According to an embodiment, the stable agrochemical composition comprises triazinylsulfonylurea herbicide in an amount from about 0.1% w/w to about 60% w/w, the silicate carrier in an amount from about 5% w/w to about 60% w/w and salt(s) of sulfonic acid derivative in an amount from about 1% w/w to about 20% w/w of the total weight of the composition.

According to an embodiment, the stable agrochemical composition comprises tribenuron-methyl in an amount from about 0.1% w/w to about 20% w/w, thifensulfuron-methyl in an amount from about 5% w/w to about 60% w/w, a polymeric carrier in an amount from about 5% w/w to about 60% w/w and salt(s) of sulfonic acid derivative in an amount from about 1% w/w to about 20% w/w of the total weight of the composition.

According to an embodiment, the stable agrochemical composition comprises tribenuron-methyl in an amount from about 0.1% w/w to about 20% w/w, thifensulfuron-methyl in an amount from about 5% w/w to about 60% w/w, the silicate carrier in an amount from about 5% w/w to about 60% w/w and salt(s) of sulfonic acid derivative in an amount from about 1% w/w to about 20% w/w of the total weight of the composition.

According to an embodiment, the stable agrochemical composition comprises tribenuron-methyl in an amount from about 0.1% w/w to about 20% w/w, thifensulfuron-methyl in an amount from about 5% w/w to about 60% w/w, the silicate carrier in an amount from about 5% w/w to about 60% w/w, the salt(s) of sulfonic acid derivative in an amount from about 1% w/w to about 20% w/w and the agrochemically acceptable excipient in an amount from about 0.1% w/w to about 30% w/w of the total weight of the composition.

According to an embodiment, the present disclosure provides a stable agrochemical composition comprising:
a) at least one triazinylsulfonylurea herbicide, its agriculturally acceptable salts, and esters thereof; and
b) a stabilizer system comprising a polymeric carrier and at least two salts of sulfonic acid derivatives;
   wherein the stable agrochemical composition is in a form of a solid formulation.

In an embodiment, the stable agrochemical composition is selected from Capsule suspension (CS), Dispersible concentrate (DC), Emulsifiable concentrate (EC), Emulsion, water in oil (EO), Emulsion, oil in water (EW), Micro-emulsion (ME), Oil dispersion (OD), Oil miscible flowable concentrate (oil miscible suspension (OF), Oil miscible liquid (OL), Suspension concentrate (SC), Suspo-emulsion (SE), Soluble concentrate (SL), Water dispersible granule (WG or WDG), Water soluble granule (SG), Water soluble powder (SP), Wettable powder (WP), or combinations thereof.

According to an embodiment, the stable agrochemical composition is present in a form of a water dispersible granule (WG or WDG).

In an embodiment, the present invention provides a solid agrochemical composition comprising:
a) at least one triazinylsulfonylurea herbicide, its agriculturally acceptable salts, and esters thereof;
b) a stabilizer system comprising a polymeric carrier and at least two salts of sulfonic acid derivatives; and
c) optionally an agrochemically acceptable excipient.

In an embodiment, the present invention provides a WDG agrochemical composition comprising:
a) at least one triazinylsulfonylurea herbicide, its agriculturally acceptable salts, and esters thereof;
b) a stabilizer system comprising a polymeric carrier and at least two salts of sulfonic acid derivatives; and
c) optionally an agrochemically acceptable excipient.

In an embodiment, the present invention provides a WDG agrochemical composition comprising:
a) at least one triazinylsulfonylurea herbicide, its agriculturally acceptable salts, and esters thereof;
b) a stabilizer system comprising a silicate carrier and at least two salts of sulfonic acid derivatives; and
c) optionally an agrochemically acceptable excipient.

In an embodiment, the present invention provides a WDG agrochemical composition comprising:
a) two triazinylsulfonylurea herbicides, its agriculturally acceptable salts, and esters thereof;
b) a stabilizer system comprising a silicate carrier and at least two salts of sulfonic acid derivatives; and
c) optionally an agrochemically acceptable excipient.

In an embodiment, the present invention provides a WDG agrochemical composition comprising two triazinylsulfonylurea herbicides, its agriculturally acceptable salts, and esters thereof; and a stabilizer system comprising a silicate carrier and at least two salts of sulfonic acid derivatives, either in the form of a tank mix or a pre-formulated (pre-mix) composition.

In an embodiment, the present invention provides a WDG agrochemical composition comprising two triazinylsulfonylurea herbicides, its agriculturally acceptable salts, and esters thereof; and a stabilizer system comprising a silicate carrier and at least two salts of sulfonic acid derivatives, in the form of a pre-formulated (pre-mix) composition.

According to an embodiment, the WDG composition comprises two triazinylsulfonylurea herbicides, wherein the two triazinylsulfonylurea herbicides comprises thifensulfuron-methyl and tribenuron-methyl.

According to an embodiment, the WDG composition comprises thifensulfuron-methyl and tribenuron-methyl, wherein thifensulfuron-methyl and tribenuron-methyl are present in a ratio of active ingredients of 50:450.

According to an embodiment, the stable agrochemical composition is used for controlling undesired plant growth.

In an embodiment, the present disclosure provides use of a stable agrochemical composition comprising at least one triazinylsulfonylurea herbicide, its agriculturally acceptable salts, and esters thereof; and a stabilizer system comprising a polymeric carrier and at least two salts of sulfonic acid derivatives, for controlling weeds.

In an embodiment, the present disclosure provides use of a stable agrochemical composition comprising two triazinylsulfonylurea herbicides, its agriculturally acceptable salts, and esters thereof; and a stabilizer system comprising a silicate carrier and at least two salts of sulfonic acid derivatives, for controlling weeds.

According to an embodiment, the present disclosure provides a process for the preparation of a stable agrochemical composition, the process comprising:
a) mixing at least one triazinylsulfonylurea herbicide and a stabilizer system, comprising a polymeric carrier and at least two salts of sulfonic acid derivatives, to obtain a homogeneous mixture;
b) granulating the homogeneous mixture of step (a) to obtain granules; and
c) drying the granules to obtain the stable agrochemical composition.

According to an embodiment, the present disclosure provides a process for the preparation of a stable agrochemical composition, the process comprising:
a) mixing at least one triazinylsulfonylurea herbicide and a stabilizer system, comprising a silicate carrier and at least two salts of sulfonic acid derivatives, to obtain a homogeneous mixture;
b) granulating the homogeneous mixture of step (a) to obtain granules; and
c) drying the granules to obtain the stable agrochemical composition.

According to an embodiment, the process of preparing stable agrochemical composition of the present disclosure results into WDG formulation, wherein the step (b) of granulating comprises pan granulation, spray drying, or extrusion.

According to an embodiment, the process of preparing stable agrochemical composition of the present disclosure results into WDG formulation, wherein the step (b) of granulating comprises extrusion.

According to an embodiment, the process for the preparation of a stable agrochemical composition of the present disclosure comprises:
a) mixing at least two triazinylsulfonylurea herbicides and a stabilizer system comprising a silicate carrier and at least two salts of sulfonic acid derivatives to obtain a homogeneous mixture;
b) preparing a dough by adding water to the homogeneous mixture of step (a);
c) extruding the dough to obtain granules; and
d) drying the granules to obtain the stable agrochemical composition.

According to an embodiment, the order of addition and mixing of the agrochemical ingredients or excipients is not narrowly critical. In one embodiment, for example, the dry ingredients are blended, and the composition is then mixed with water to obtain a dough.

According to an embodiment, water may be added as a fine spray to prepare dough from the composition to obtain granules.

According to an embodiment, the homogeneous mixture of above ingredients is obtained using a suitable blender such as ribbon blender, V-blender, high intensity low mixer, plough shear Mixer, kneader mixer, or the like thereof.

According to an embodiment, blend of triazinylsulfonylurea herbicide, the stabilizer system along with agrochemically acceptable excipients may be milled to obtain a uniform blend.

The grinding may be performed in a suitable device such as air jet mill, air classifier mill, hammer mill, pin disc mill, or the like thereof. Jet mills are shear or pulverizing machines in which the particles to be milled are accelerated by gas flows and pulverized by collision. There are a number of different types of jet mill designs, such as double counterflow (opposing jet) and spiral (pancake) fluid energy mills.

According to an embodiment, drying of granules may be performed in a suitable drying equipment such as spray drier or fluidized bed spray drier or fluid bed spray granulator.

According to an embodiment, the drying of extruded granules operates at a temperature ranging from 40 to 80° C.

According to a preferred embodiment, the drying of granules operates at a temperature ranging from 40 to 65° C.

According to a preferred embodiment, the drying of granules operates at a temperature of 50° C.

According to an embodiment, materials used in the process of the disclosure may be in a finely divided form, preferably in an air-milled form which is generally the form of commercial grade chemicals supplied by manufacturers.

In an embodiment, pH of the spray solution ranges between 4.0 to 7.0.

According to an embodiment of the present disclosure, the stable agrochemical composition comprising at least one triazinylsulfonylurea herbicide, its agriculturally acceptable salts, and esters thereof; and a stabilizer system comprising a polymeric carrier and at least two salts of sulfonic acid derivatives result into pH value between 4.0-7.0 when diluted with water to make a spray solution.

According to an embodiment of the present disclosure, the stable agrochemical composition comprising two triazinylsulfonylurea herbicide, its agriculturally acceptable salts, and esters thereof; and a stabilizer system comprising a silicate carrier and at least two salts of sulfonic acid derivatives result into pH value between 4.0-7.0 when diluted with water to make a spray solution.

According to an embodiment, the stable agrochemical composition has a particle size distribution (D₅₀) ranging from 1-20 μm.

According to an embodiment, the stable agrochemical composition has a particle size distribution (D₅₀) ranging from 1-15 μm.

According to an embodiment, the stable agrochemical composition has a particle size distribution (D₅₀) ranging from 1-10 μm.

According to an embodiment, the stable agrochemical composition has a particle size distribution (D₅₀) ranging from 2-8 μm.

According to an embodiment, the stable agrochemical composition has a particle size distribution (D₅₀) of 2.73 μm.

According to an embodiment, the stable agrochemical composition has a particle size distribution (D₅₀) of 6.75 μm.

In an embodiment, the present disclosure provides a method for controlling degradation of a triazinylsulfonylurea herbicide, its agriculturally acceptable salts, and esters thereof, the method comprising: adding a stabilizer system comprising a polymeric carrier and at least two salts of sulfonic acid derivatives to at least one triazinylsulfonylurea herbicide, its agriculturally acceptable salts, and esters thereof.

In an embodiment, the present disclosure provides a method for controlling degradation of a triazinylsulfonylurea herbicide, its agriculturally acceptable salts, and esters thereof, the method comprising: adding a stabilizer system comprising a silicate carrier and at least two salts of sulfonic acid derivatives to two triazinylsulfonylurea herbicides, its agriculturally acceptable salts, and esters thereof.

According to an embodiment, the present disclosure provides a method for treating plants by applying to the plants or to their locus thereof, a stable agrochemical composition comprising at least one triazinylsulfonylurea herbicide, its agriculturally acceptable salts, and esters thereof; and a stabilizer system comprising a polymeric carrier and at least two salts of sulfonic acid derivatives.

According to an embodiment, the present disclosure provides a method for treating plants by applying to the plants or to their locus thereof, a stable agrochemical composition comprising at least one triazinylsulfonylurea herbicide, its agriculturally acceptable salts, and esters thereof; and a stabilizer system comprising a silicate carrier and at least two salts of sulfonic acid derivatives.

According to an embodiment, the present disclosure provides a method for treating plants by applying to the plants or to their locus thereof, a stable agrochemical composition comprising: tribenuron-methyl; and a stabilizer system comprising a silicate carrier and at least two salts of sulfonic acid derivatives.

According to an embodiment, the present disclosure provides a method for treating plants by applying to the plants or to their locus thereof, a stable agrochemical composition comprising: thifensulfuron-methyl; and a stabilizer system comprising a silicate carrier and at least two salts of sulfonic acid derivatives.

According to an embodiment, the present disclosure provides a method for treating plants by applying to the plants or to their locus thereof, a stable agrochemical composition comprising: two triazinylsulfonylurea herbicide, its agriculturally acceptable salts, and esters thereof; and a stabilizer system comprising a silicate carrier and at least two salts of sulfonic acid derivatives.

According to an embodiment, the present disclosure provides a method for treating plants by applying to the plants or to their locus thereof, a stable agrochemical composition comprising: tribenuron-methyl and thifensulfuron-methyl herbicides; and a stabilizer system comprising a silicate carrier and at least two salts of sulfonic acid derivatives.

According to an embodiment, the present disclosure provides a method for treating plants by applying to the plants or to their locus thereof, a stable agrochemical composition comprising: tribenuron-methyl, thifensulfuron-methyl, and a stabilizer system comprising silicate carrier and at least two salts of sulfonic acid derivatives; and wherein said stabilizer system controls more than 80% degradation of tribenuron-methyl and thifensulfuron-methyl herbicides in a spray solution.

According to an embodiment, the present disclosure provides a method for controlling weeds by applying to the weeds or to their locus thereof, a stable agrochemical composition comprising at least one triazinylsulfonylurea herbicide, its agriculturally acceptable salts, and esters thereof; and a stabilizer system comprising a polymeric carrier and at least two salts of sulfonic acid derivatives.

According to an embodiment, the present disclosure provides a method for controlling weeds by applying to the weeds or to their locus thereof, a stable agrochemical composition comprising at least one triazinylsulfonylurea herbicide, its agriculturally acceptable salts, and esters thereof; and a stabilizer system comprising a silicate carrier and at least two salts of sulfonic acid derivatives.

According to an embodiment, the present disclosure provides a method for controlling weeds by applying to the weeds or to their locus thereof, a stable agrochemical composition comprising: tribenuron-methyl; and a stabilizer system comprising a silicate carrier and at least two salts of sulfonic acid derivatives.

According to an embodiment, the present disclosure provides a method for controlling weeds by applying to the weeds or to their locus thereof, a stable agrochemical composition comprising: thifensulfuron-methyl; and a stabilizer system comprising a silicate carrier and at least two salts of sulfonic acid derivatives.

According to an embodiment, the present disclosure provides a method for controlling weeds by applying to the weeds or to their locus thereof, a stable agrochemical composition comprising: two triazinylsulfonylurea herbicide, its agriculturally acceptable salts and esters thereof; and a stabilizer system comprising a silicate carrier and at least two salts of sulfonic acid derivatives.

According to an embodiment, the present disclosure provides a method for controlling weeds by applying to the weeds or to their locus thereof, a stable agrochemical composition comprising: tribenuron-methyl and thifensulfuron-methyl herbicides; and a stabilizer system comprising a silicate carrier and at least two salts of sulfonic acid derivatives.

The stable agrochemical composition of the present disclosure maybe used to target weeds among the crops such as rice, wheat, barley, rye, oat, Sorghum, cotton, soybean, peanut, buckwheat, beet, rapeseed, sunflower, durum wheat, fall wheat, field corn, winter barley, cotton, fall barley, fallow, spring wheat, triticale, winter wheat, sugar cane, tobacco, etc.; vegetables; solanaceous vegetables such as eggplant, tomato, pimento, popper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc. strawberry, sweet potato, Dioscorea japonica, colocasia, etc., flowers, foliage plants, turf grasses, fruits: pome fruits such apple, pear, quince, etc. stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees otter than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova. Japanese arborvitae, fir wood, hemlock, juniper, Pinus, Picea, and Taxus cuspidate, etc.

According to a preferred embodiment, the stable agrochemical composition is used to target weeds among the crops such as canola, durum wheat, fall wheat, field corn, rapeseed, spring barley, sugar beet, winter barley, cotton, fall barley, fallow, grain Sorghum, rice, soybean, spring wheat, triticale, winter wheat.

According to an embodiment, target weeds may be selected from Alopecurus myosuroides Huds, (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf, or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea, or Urochloa plantaginea (alexandergrass, BRAPL), Cenchrus echinatus (southern sandbar, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (Goosegrass, ELEIN), Lolium multiflorum Lam. (Italian ryegrass, LOLMU), Panicum dichlotomiflorum Michx. (Fall panicum, PANDI), Panicurn miliaceum L. (wild-proso millet, PANMI), Sesbania exaltata (hemp Sesbania, SEBEX), Setaria faberi Herrm. (Giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemislifolia L. (common ragweed, AMBEL), Ambrosia psilostachya DC. (Western ragweed, AMBPS), Ambrosia trifida (giant ragweed, AMBTR), Arioda aristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canaderisis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Portulaca oleracoa (common purslane, POROL), Richardia species (pusley, RCHSS), Salsola tragus (Russian thistle, SASKR), Sida species (Sida, SIDSS), Sida spinosa (prickly Sida, SIDSP), Sinapis arvensis (wild mustard, SINAR), Solanum ptychanthum (eastern black nightshade, SOLPT), Tridax procumbens (coat buttons, TRQPR), or Xanthium strumarium (common cocklebur, XANST).

According to an embodiment, the present disclosure may be applied either pre- or post-emergence of the weeds. The advantage of the stable agrochemical composition is good dilution stability and controlled or less degradation of the triazinylsulfonylurea herbicides.

According to an embodiment, the stable agrochemical composition comprises at least two triazinylsulfonylurea herbicides, its agriculturally acceptable salts, and esters thereof, wherein triazinylsulfonylurea herbicide comprises tribenuron-methyl or thifensulfuron-methyl.

According to an embodiment, the stable agrochemical composition comprises tribenuron-methyl, wherein tribenuron-methyl is applied at a rate of 250-500 g a.i./ha.

According to an embodiment, the stable agrochemical composition comprises tribenuron-methyl, wherein tribenuron-methyl is applied at a rate of 450 g a.i./ha.

According to an embodiment, the stable agrochemical composition comprises thifensulfuron-methyl, wherein thifensulfuron-methyl is applied at a rate of 1-150 g a.i./ha.

According to an embodiment, the stable agrochemical composition comprises thifensulfuron-methyl, wherein thifensulfuron-methyl is applied at a rate of 50 g a.i./ha.

According to an embodiment of the present disclosure, the various components of the agrochemical composition can be used individually or already partially or completely mixed with at least one other to prepare the composition according to the disclosure. It is also possible for them to be packaged and used further as composition such as a kit of parts.

According to an embodiment, there is provided a kit comprising: a stable agrochemical composition. The kit comprises a plurality of components, each of which components may include at least one, or more, of the ingredients of the stable agrochemical composition of the present disclosure.

According to an embodiment, there is provided a kit comprising: at least one triazinylsulfonylurea herbicide or an agriculturally acceptable salt, and esters thereof; and a stabilizer system comprising a polymeric carrier and at least two salts of sulfonic acid derivatives.

According to an embodiment, there is provided a kit comprising: at least one triazinylsulfonylurea herbicide or an agriculturally acceptable salt, and esters thereof; and a stabilizer system comprising a silicate carrier and at least two salts of sulfonic acid derivatives.

In one embodiment, the kits may include one or more, including all, components that may be used to prepare the stable agrochemical composition. E.g., kits may include triazinylsulfonylurea herbicides and a stabilizer system comprising a silicate carrier and at least two salts of sulfonic acid derivatives. One or more of the components may already be combined or pre-formulated. In those embodiments where more than two components are provided in a kit, the components may already be combined and as such are packaged in a single container such as a vial, bottle, can, pouch, bag or canister.

It will be understood that the specification and examples are illustrative but not limiting of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the claims.

### EXAMPLES

### Example 1: Preparation of Thifensulfuron-Methyl 50+Tribenuron-Methyl 450 WDG

| Ingredients | Quantity (% w/w) |
|---|---|
| Thifensulfuron-methyl | 5.20 |
| Tribenuron-methyl | 47.17 |
| Sodium carbonate | 4.82 |
| Sodium dodecylbenzenesulphonate | 3.00 |
| Sodium lignosulfonate | 9.00 |
| Kaolin clay | Q.S. |
| Total | 100 |

5.20 g thifensulfuron-methyl and 47.17 g tribenuron-methyl were mixed and a stabilizer comprising 3 g sodium dodecylbenzene sulfonate, 9 g sodium lignosulfonate and kaolin clay was further added (as per requirement) and blended to obtain a homogeneous mixture. Further 4.82 g sodium carbonate was added to the mixture. Dough was prepared from the mixture by adding water and extruded to obtain granules and granules were dried to obtain stable agrochemical composition.

### Example 2: Preparation of Thifensulfuron-Methyl 50+Tribenuron-Methyl 450 WDG

| Ingredients | Quantity (% w/w) |
|---|---|
| Thifensulfuron-methyl | 5.20 |
| Tribenuron-methyl | 47.17 |
| Sodium carbonate | 6.3 |
| Sodium alkylbenzenesulfonate | 3.00 |
| Sodium lignosulfonate | 9.00 |
| Kaolin clay | Q.S. |
| Total | 100 |

Thifensulfuron-methyl, tribenuron-methyl, sodium carbonate, sodium alkylbenzenesulphonate, sodium lignosulfonate and kaolin were mixed in the aforementioned quantities and a WDG formulation was prepared according to the process of Example-1.

### Example 3: Preparation of Tribenuron-Methyl 450 WDG

| Ingredients | Quantity (% w/w) |
|---|---|
| Tribenuron-methyl TG 97.45% | 46.18 |
| Sodium carbonate | 4.82 |
| Sodium alkylbenzenesulfonate | 3.00 |
| Sodium lignosulfonate | 9.00 |
| Kaolin clay | Q.S. |
| Total | 100 |

Tribenuron-methyl, sodium carbonate, sodium alkylbenzenesulphonate, sodium lignosulfonate and kaolin were mixed in the aforementioned quantities and a WDG formulation was prepared according to the process of Example-1.

### Example 4: Preparation of Thifensulfuron-Methyl 50 WDG

| Ingredients | Quantity (% w/w) |
|---|---|
| Thifensulfuron-methyl | 5.20 |
| Sodium carbonate | 4.82 |
| Sodium alkylbenzenesulfonate | 3.00 |
| Sodium lignosulfonate | 9.00 |
| Kaolin clay | Q.S. |
| Total | 100 |

Thifensulfuron-methyl, sodium carbonate, sodium alkylbenzenesulphonate, sodium lignosulfonate and kaolin were mixed in the aforementioned quantities and a WDG formulation was prepared according to the process of Example-1.

### Example 5: Stability Study

The compositions of Example-1 and Example-2 were studied to assess the stability of the active ingredients first at 25° C., after 2 months at 40° C. and after 3 months at 35° C. The active ingredients thifensulfuron-methyl and tribenuron-methyl in both the compositions of Example-1 and Example-2 remained quite stable. It was found that both the actives remained quite stable with more than 99% recovery of thifensulfuron-methyl; and more than 95% recovery of tribenuron-methyl. Overall, both the compositions of Example-1 and Example-2 were found to be satisfactory in stability study. The results have been formulated in Table 1.

TABLE 1
Stability Study
Stability Study

| | Example-1 | | | Example-2 | | |
|---|---|---|---|---|---|---|
| | Interval | | | | | |
| | 0 days | 2 Months | 3 Months | 0 days | 2 Months | 3 Months |
| | Temperature (° C.) | | | | | |
| | 25° C. | 40° C. | 35° C. | 25° C. | 40° C. | 35° C. |
| Thifensulfuron- | 4.98 | 5.04 | 5.07 | 4.90 | 4.92 | 4.89 |
| methyl content | | | | | | |
| (% w/w) | | | | | | |
| Recovery versus | — | 101.2 | 101.8 | — | 100.4 | 99.8 |
| Initial (%) | | | | | | |
| Tribenuron- | 45.06 | 42.85 | 44.12 | 45.00 | 44.30 | 44.43 |
| methyl content | | | | | | |
| (% w/w) | | | | | | |
| Recovery versus | — | 95.1 | 97.9 | — | 98.4 | 98.7 |
| Initial (%) | | | | | | |

### Example 6: Dispersibility & Sedimentation Testing

The compositions of Example-1 and Example-2 were tested for dispersibility as well as sedimentation to ensure stability of the composition. The method involved the determination of the sample dispersibility using a test sample (maximum dose rate), which was added to 100 mL of Standard Hard Water in a 100 mL graduated centrifuge tube. The tube was inverted repeatedly, and the number of inversions required for complete dispersion of the granules was recorded. The tube was made to stand undisturbed for 24 hours. Volume separation was recorded after 15 minutes, 30 minutes, 1 hour, 4 hours and 24 hours. The results have been formulated in Table-2.

TABLE 2
Dispersibility & Sedimentation Testing

| | Example-1 | | Example-2 | |
|---|---|---|---|---|
| | Interval | | | |
| | 0 days | 3 Months | 0 days | 3 Months |
| | Temperature (° C.) | | | |
| | 25° C. | 35° C. | 25° C. | 35° C. |
| Dispersion behaviour | 26 inversions | 29 inversions | 29 inversions | 26 inversions |

Sedimentation

| | | | | |
|---|---|---|---|---|
| 15 Minutes | Trace | Trace | Trace | Trace |
| 30 Minutes | Trace | 0.025 | Trace | Trace |
| 1 Hour | 0.025 | <0.05 | Trace | Trace |
| 4 Hours | <0.05 | 0.1 | <0.05 | <0.05 |
| 24 Hours | 0.2 | 0.15 | <0.05 | <0.05 |
| Redisperse (No. of | >30 | 25 | 10 | 10 |
| Inversions) | | | | |
| 24 Hours + 30 Minutes | Trace | 0.025 | <0.05 | <0.05 |

### Example 7: Suspensibility Study

In the suspensibility study performed, the pH of the compositions of Example-1 and Example-2 were found to be near neutral. Particle size D₅₀ remained between 2.73 to 6.75 μm. Persistent foam range was within acceptable limit. Wet sieve results were also found to be satisfactory. Suspensibility using CIPAC method at the maximum dose rate (0.045%) was also calculated. Duration was 30 minutes. Both the actives were found to have suspensibility above 98%. Spontaneity of the dispersion was also found to be above 90%. The results have been formulated in Table 3.

TABLE 3
Suspensibility study

| | |
|---|---|
| Example-1 | Example-2 |

0 days 25° C.

| | | |
|---|---|---|
| pH at 1% Dilution | 6.8 | 7.1 |

Particle Size

| | | |
|---|---|---|
| D₅₀ (μm) | 2.73 | 6.75 |

Persistent foam CIPAC D RT max dose

| | | |
|---|---|---|
| 1 min | 48 mL | 40 mL |
| 12 min | 46 mL | 40 mL |

Wet sieve test

| | | |
|---|---|---|
| Retained on 40 μm (%) | 0.020 | 0.000 |
| Retained on 75 μm (%) | 0.030 | <0.010 |

Suspensibility, Max dose, CIPAC D 30° C.

| | | |
|---|---|---|
| Thifensulfuron-methyl (%) | 99.6 | 99.7 |
| Tribenuron-methyl (%) | 98.6 | 100.3 |
| Spontaneity of dispersion (%) | 93.1 | 98.6 |

### Example 8: Study of Stability of Triazinylsulfonylurea Herbicides in Spray Solutions

The composition of Example-1 was diluted to prepare tank-mix and the recovery percentage of thifensulfuron-methyl and tribenuron-methyl was observed at various intervals of time from 0 hours, 2 hours, 4 hours, 6 hours and 24 hours. It was observed that the thifensulfuron-methyl remained quite stable in tank dilution over the period of 24 hours without much degradation. Only 0.4% degradation was observed in 24 hours. Similarly, Tribenuron-methyl remained stable in tank dilution and around 20% degradation was observed in 24 hours which was within the acceptable range. The results have been formulated in Table 4.

TABLE 4
Stability of triazinylsulfonylurea herbicides in spray solutions

| | Thifensulfuron-methyl | | | | Tribenuron-methyl | | | |
|---|---|---|---|---|---|---|---|---|
| Time | ⁺RT | Area | Relative | Recovery | RT | Area | Relative | Recovery |
| (Hrs) | min | mAU*min | Area | % | Min | mAU*min | Area | % |
| 0 | 3.990 | 1.0744 | 0.0843 | 100.0 | 9.927 | 15.4051 | 1.2084 | 100.0 |
| 2 | 3.990 | 1.0649 | 0.0841 | 99.8 | 9.920 | 15.0716 | 1.1909 | 98.6 |
| 4 | 3.990 | 1.0677 | 0.0844 | 100.1 | 9.920 | 14.7871 | 1.1685 | 96.7 |
| 6 | 3.990 | 1.0629 | 0.0838 | 99.5 | 9.913 | 14.3672 | 1.1333 | 93.8 |
| 24 | 3.993 | 1.0658 | 0.0840 | 99.6 | 9.920 | 12.3225 | 0.9708 | 80.3 |

⁺RT: Retention time;
ISTD: Internal standard;
mAU*min (Area of peak = absorbance(mAU) × min).

### Example 9: Comparative Study of Triazinylsulfonylurea Herbicides in Tank Dilutions

The tank dilutions were prepared with the compositions of Example-1, Example-2 and Example-3 and these compositions were compared against market standards (thifensulfuron-methyl and tribenuron-methyl). Recovery percentage of thifensulfuron-methyl and tribenuron-methyl were observed for the compositions of Example-1 to 3 as well as for market standards. It was found that thifensulfuron-methyl remained quite stable in all the three compositions. However, around 40% degradation of tribenuron-methyl was observed in market standards in 24 hours making it unsuitable for further application onto crops. Whereas tribenuron-methyl found to remain quite stable in the composition of Example-1 (i.e., recovery 80.3%), Example-2 (i.e., recovery 87.8%) and Example-3 (i.e., recovery 88.7%). The results have been formulated in Table 5.

TABLE 5
Comparative study of triazinylsulfonylurea herbicides

| | | | | |
|---|---|---|---|---|
| Thifensulfuron- | Tribenuron- | Thifensulfuron- | Tribenuron- | Tribenuron- |
| methyl | methyl | methyl | methyl | methyl |

| | | | | | |
|---|---|---|---|---|---|
| Time | Thifensulfuron- | Tribenuron- | Composition | Composition | Composition |
| (hours) | methyl | methyl | Example-1 | Example-2 | Example-3 |

% Recovery

| | | | | | | | |
|---|---|---|---|---|---|---|---|
| 0 | 100.0 | 100.0 | 100.0 | 100.0 | 100.0 | 100.0 | 100.0 |
| 2 | 101.7 | 97.7 | 99.8 | 98.6 | 100.5 | 98.9 | 103.4 |
| 4 | 99.3 | 90.9 | 100.1 | 96.7 | 100.7 | 98.4 | 102.1 |
| 6 | 101.3 | 88.2 | 99.5 | 93.8 | 100.3 | 97.1 | 100.5 |
| 24 | 101.0 | 65.9 | 99.6 | 80.3 | 100.0 | 87.8 | 88.7 |

Therefore, inventors of the present disclosure successfully developed stable agrochemical composition of triazinylsulfonylurea herbicide(s). The composition is found to exhibit longer stability in tank dilution. Both thifensulfuron-methyl and tribenuron-methyl degradation are found to be controlled in the presence of the stabilizer comprising silicate carrier and salts of sulfonic acid derivative. It is clear from the experimental data, as described above, that the stabilizer comprising silicate carrier and salt of sulfonic acid derivative of the present disclosure is effective in preventing degradation of thifensulfuron-methyl and tribenuron-methyl. The composition remained quite stable during transport and shelf life. As such, the spirit and scope of the disclosure should not be limited to the description of the preferred embodiment contained therein.

1. An agrochemical composition comprising:
a) at least one triazinylsulfonylurea herbicide, its agriculturally acceptable salts, and esters thereof; and
b) a stabilizer system comprising a polymeric carrier and at least two salts of sulfonic acid derivatives.

2. The composition as claimed in claim 1, wherein the triazinylsulfonylurea herbicide is selected from the group consisting of chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, its agriculturally acceptable salts, and esters thereof.

3. The composition as claimed in claim 1, wherein the triazinylsulfonylurea herbicide is tribenuron-methyl or thifensulfuron-methyl.

4. The composition as claimed in claim 1, wherein the composition comprises from about 1% w/w to about 60% w/w triazinylsulfonylurea herbicide of total weight of the composition.

5. The composition as claimed in claim 1, wherein the polymeric carrier is a silicate carrier.

6. The composition as claimed in claim 5, wherein the silicate carrier is selected from the group consisting of kaolin clay, bentonite clay, modified bentonite clay, activated bentonites, synthetic and diatomaceous silicas, and mixtures thereof.

7. The composition as claimed in claim 1, wherein the salts of sulfonic acid derivatives are selected from the group consisting of alkyl naphthalene sulfonates, lignosulphonates, alkylbenzene sulphonate, their salts, derivatives, blends, and mixtures thereof.

8. The composition as claimed in claim 7, wherein the salts of sulfonic acid derivatives are selected from the group consisting of sodium butyl naphthalene sulfonate, sodium nonyl naphthalene sulfonate, sodium alkyl naphthalene sulfonate blend, condensate of aromatic sulfonic acids, sodium isopropyl naphthalene sulfonate, sodium dodecylbenzenesulphonate, sodium lauryl sulfate, calcium dinonyl naphthalene sulfonate, naphthalene sulfonate-formaldehyde condensate, alkyl substituted naphthalene sulfonate-formaldehyde condensates, sodium alkyl naphthalene sulfonate, sodium salt of sulfonated naphthalene-formaldehyde condensate, sodium lignosulfonate, modified sodium lignosulfonate, calcium lignosulfonate, linear dodecylbenzene sulfonic acid, branched dodecylbenzene sulfonic acid, and linear dodecylbenzene sulfonate isopropylamine salt.

9. The composition as claimed in claim 1, wherein the polymeric carrier; and the at least two salts of sulfonic acid derivatives are present in a ratio ranging from 1:1 to 20:1.

10. The composition as claimed in claim 1, wherein the composition is in a form of a solid formulation.

11. The composition as claimed in claim 10, wherein the solid formulation comprises water dispersible granules (WDG).

12. A solid agrochemical composition comprising:
a) at least two triazinylsulfonylurea herbicide, its agriculturally acceptable salts, and esters thereof;
b) a stabilizer system comprising a polymeric carrier and at least two salts of sulfonic acid derivatives; and
c) optionally an agrochemically acceptable excipient.

13. The composition as claimed in claim 12, wherein the agrochemically acceptable excipient are selected from one or more of dispersants, colorants, binders, antifoaming agents, antioxidants, solvents, preservatives, glidants, anticaking agents, pH-regulating agents, buffering agents, formulation aids, or combinations thereof.

14. The composition as claimed in claim 12, wherein the composition comprises the triazinylsulfonylurea herbicide in an amount from about 0.1% w/w to about 60% w/w, the polymeric carrier in an amount from about 5% w/w to about 70% w/w, the salts of sulfonic acid derivative in an amount from about 1% w/w to about 20% w/w and the agrochemically acceptable excipient in an amount from about 0.1% w/w to about 30% w/w of total weight of the composition.

15. The composition as claimed in claim 12, wherein said composition comprises tribenuron-methyl in an amount from about 0.1% w/w to about 20% w/w, thifensulfuron-methyl in an amount from about 5% w/w to about 60% w/w, the polymeric carrier in an amount from about 5% w/w to about 60% w/w, the salts of sulfonic acid derivative in an amount from about 1% w/w to about 20% w/w and the agrochemically acceptable excipient in an amount from about 0.1% w/w to about 30% w/w of total weight of the composition.

16. Use of a stable agrochemical composition comprising at least one triazinylsulfonylurea herbicide, its agriculturally acceptable salts, and esters thereof and a stabilizer system comprising a polymeric carrier and at least two salts of sulfonic acid derivatives, for controlling weeds.

17. A process for preparing a stable agrochemical composition, the process comprising:
a) mixing at least one triazinylsulfonylurea herbicide and a stabilizer system, comprising a polymeric carrier and at least two salts of sulfonic acid derivatives, to obtain a homogeneous mixture;
b) granulating the homogeneous mixture of step (a) to obtain granules; and
c) drying the granules to obtain the stable agrochemical composition.

18. The process as claimed in claim 17, wherein the triazinylsulfonylurea herbicide comprises tribenuron-methyl, thifensulfuron-methyl, and combinations thereof.

19. The process as claimed in claim 17, wherein step (b) of granulating comprises pan granulation, spray drying, or extrusion.

20. A method for controlling weeds, the method comprising:
applying to a plant or to a locus thereof, a stable agrochemical composition comprising:
a) at least one triazinylsulfonylurea herbicide, its agriculturally acceptable salts, and esters thereof; and
b) a stabilizer system comprising a polymeric carrier and at least two salts of sulfonic acid derivatives;
wherein the stabilizer system controls degradation of the triazinylsulfonylurea herbicide in a spray solution.
